(19) United States
(12) Patent Application Publication
(10) Pub. No.: US 2018/0131052 A1
(43) Pub. Date: May 10, 2018

(54) BATTERY THERMAL MANAGEMENT SYSTEMS FOR ELECTRIFIED VEHICLES

(71) Applicant: FORD GLOBAL TECHNOLOGIES, LLC, Dearborn, MI (US)

(72) Inventors: Michael E. REIBLING, Sterling Heights, MI (US); Steven Michael CYR, Lake Orion, MI (US); Ray C. SICIAK, Ann Arbor, MI (US)

(21) Appl. No.: 15/346,028

(22) Filed: Nov. 8, 2016

(51) Int. Cl. H01M 10/625; H01M 10/613; H01M 10/635; H01M 10/663; H01M 10/48; B60H 1/00

(52) U.S. Cl. CPC H01M 10/625; H01M 10/613; H01M 10/635; H01M 10/663; B60H 2001/003; B60H 1/00278; B60H 1/00385; B60H 1/00864; H01M 2220/20; H01M 10/486

(57) ABSTRACT

An electrified vehicle includes a vehicle body establishing an interior space, a battery pack mounted within the interior space, and a battery thermal management system including a control module configured to command evacuation of hot air within the interior space if an external temperature of the battery pack exceeds a predefined temperature threshold.

### TECHNICAL FIELD

This disclosure relates to battery thermal management systems for electrified vehicles. An exemplary battery thermal management system includes a control module configured to command evacuation of hot air from an interior space of the electrified vehicle to thermally manage a battery pack that is mounted within the interior space.

### BACKGROUND

The desire to reduce automotive fuel consumption and emissions is well documented. Therefore, vehicles are being developed that reduce or completely eliminate reliance on internal combustion engines. Electrified vehicles are one type of vehicle currently being developed for this purpose. In general, electrified vehicles differ from conventional motor vehicles because they are selectively driven by one or more battery powered electric machines. Conventional motor vehicles, by contrast, rely exclusively on the internal combustion engine to drive the vehicle.

A high voltage battery pack typically powers the electric machines and other electrical loads of the electrified vehicle. The battery pack includes a plurality of battery cells that must be periodically recharged to replenish the energy necessary to power these loads. The battery cells can generate heat, such as during charging and discharging operations. The mounting location of the battery pack can also contribute to high heat loads during relatively hot ambient conditions.

### SUMMARY

An electrified vehicle according to an exemplary aspect of the present disclosure includes, among other things, a vehicle body establishing an interior space, a battery pack mounted within the interior space, and a battery thermal management system including a control module configured to command evacuation of hot air within the interior space if an external temperature of the battery pack exceeds a predefined temperature threshold.

In a further non-limiting embodiment of the foregoing electrified vehicle, the battery pack is mounted within a cargo area of the interior space.

In a further non-limiting embodiment of either of the foregoing electrified vehicles, the control module is a battery electrical control module (BECM).

In a further non-limiting embodiment of any of the foregoing electrified vehicles, the battery thermal management system includes a heating, ventilation, and air conditioning (HVAC) system, at least one thermocouple, and at least one air extractor.

In a further non-limiting embodiment of any of the foregoing electrified vehicles, the control module is configured to command the HVAC system into a fresh air mode if the external temperature of the battery pack exceeds the predefined temperature threshold.

In a further non-limiting embodiment of any of the foregoing electrified vehicles, the at least one thermocouple is configured to detect the external temperature of the battery pack.

In a further non-limiting embodiment of any of the foregoing electrified vehicles, the at least one air extractor establishes a path for communicating the hot air from the interior space to an exterior of the vehicle body.

In a further non-limiting embodiment of any of the foregoing electrified vehicles, the battery thermal management system includes an air extractor and an actuator configured to change a positioning of the air extractor.

In a further non-limiting embodiment of any of the foregoing electrified vehicles, the control module is configured to command the actuator to change the positioning of the air extractor if the external temperature of the battery pack exceeds the predefined temperature threshold.

In a further non-limiting embodiment of any of the foregoing electrified vehicles, the control module is configured to command a HVAC system to command the actuator to change the positioning of the air extractor if the external temperature of the battery pack exceeds the predefined temperature threshold.

In a further non-limiting embodiment of any of the foregoing electrified vehicles, the battery thermal management system includes an air extractor and a fan configured to force the hot air through the air extractor.

In a further non-limiting embodiment of any of the foregoing electrified vehicles, the control module is configured to command the fan to force the hot air through the air extractor if the external temperature of the battery pack exceeds the predefined temperature threshold.

In a further non-limiting embodiment of any of the foregoing electrified vehicles, the battery thermal management system includes a first thermocouple configured to detect the external temperature and a second thermocouple configured to detect an internal temperature of the battery pack.

A method according to another exemplary aspect of the present disclosure includes, among other things, automatically evacuating hot air from an interior space of an electrified vehicle if an external temperature of a battery pack mounted within the interior space exceeds a predefined temperature threshold.

In a further non-limiting embodiment of the foregoing method, automatically evacuating the hot air from the interior space includes commanding a HVAC system into a fresh air mode to force the hot air out of the interior space.

In a further non-limiting embodiment of either of the foregoing methods, the method includes preventing the HVAC system from operating in a recirculation mode until the external temperature is less than the predefined temperature threshold.

In a further non-limiting embodiment of any of the foregoing methods, commanding the HVAC system into the fresh air mode includes directing fresh air through an air inlet and communicating the fresh air to the interior space to evacuate the hot air.

In a further non-limiting embodiment of any of the foregoing methods, automatically evacuating the hot air from the interior space includes changing a positioning of an air extractor positioned to establish a path for communicating the hot air from the interior space to an exterior of the electrified vehicle.

In a further non-limiting embodiment of any of the foregoing methods, automatically evacuating the hot air from the interior space includes actuating a fan to force the hot air through an air extractor.

In a further non-limiting embodiment of any of the foregoing methods, the method includes monitoring the external temperature of the battery pack and comparing the external temperature to the predefined temperature threshold both before and after automatically evacuating the hot air from the interior space.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 schematically illustrates a battery thermal management system of an electrified vehicle.

FIG. 3 schematically illustrates an exemplary control strategy for thermally managing a battery pack of an electrified vehicle.

FIG. 4 schematically illustrates another exemplary battery thermal management system.

FIG. 5 schematically illustrates another exemplary control strategy for thermally managing a battery pack of an electrified vehicle.

FIG. 6 schematically illustrates yet another exemplary battery thermal management system.

FIG. 7 schematically illustrates yet another exemplary control strategy for thermally managing a battery pack of an electrified vehicle.

### DETAILED DESCRIPTION

This disclosure describes battery thermal management systems for electrified vehicles. An exemplary battery thermal management system includes a control module configured to command an HVAC system in fresh air mode to evacuate hot air from an interior space where a battery pack is mounted. Another exemplary thermal management system includes a control module configured to command an actuator to alter a positioning of an air extractor to permit hot air to escape an interior space where a battery pack is mounted. Yet another exemplary thermal management system includes a control module configured to control a fan to force hot air from an interior space where a battery pack is mounted. These and other features are discussed in greater detail in the following paragraphs of this detailed description.

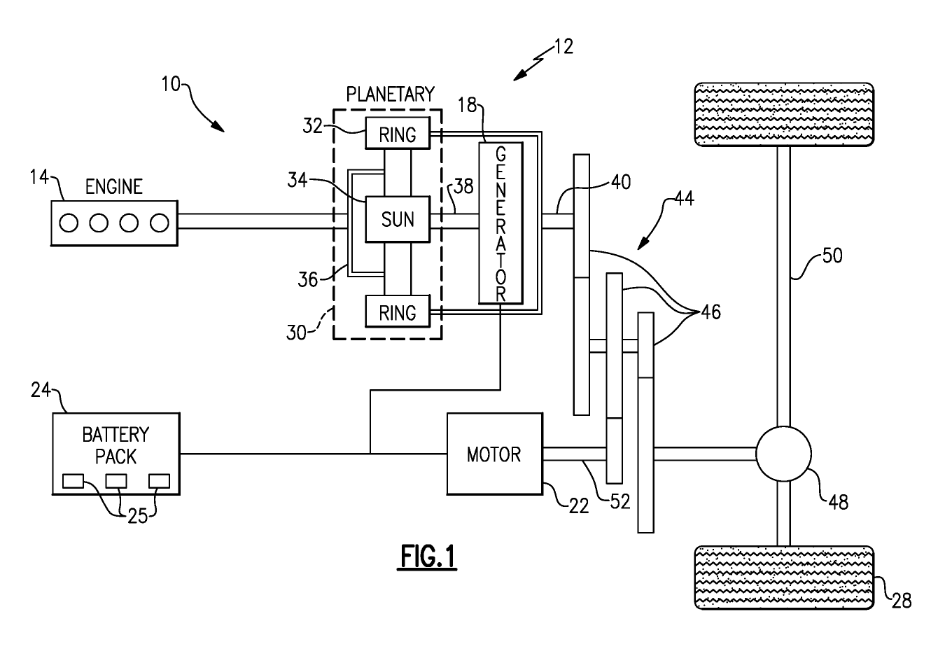

FIG. 1 schematically illustrates a powertrain 10 for an electrified vehicle 12. Although depicted as a hybrid electric vehicle (HEV), it should be understood that the concepts described herein are not limited to HEV's and could extend to other electrified vehicles, including, but not limited to, plug-in hybrid electric vehicles (PHEV's), battery electric vehicles (BEV's), fuel cell vehicles, etc.

In a non-limiting embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electrified vehicle 12. Although a power-split configuration is depicted in FIG. 1, this disclosure extends to any hybrid or electric vehicle including full hybrids, parallel hybrids, series hybrids, mild hybrids or micro hybrids.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the motor 22, the generator 18 and/or other electrical loads of the electrified vehicle 12. Other types of energy storage devices and/or output devices could also be used to electrically power the electrified vehicle 12.

In a non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

During certain conditions, a significant amount of heat can be generated by the battery cells of the battery pack 24. The temperature of the battery pack 24 can also become elevated during relatively hot ambient conditions. It is desirable to manage this heat to improve the capacity and life of the battery cells and thereby improve the operation and efficiency of the battery pack 24. Systems and methods for actively managing battery pack heat loads are therefore detailed below.

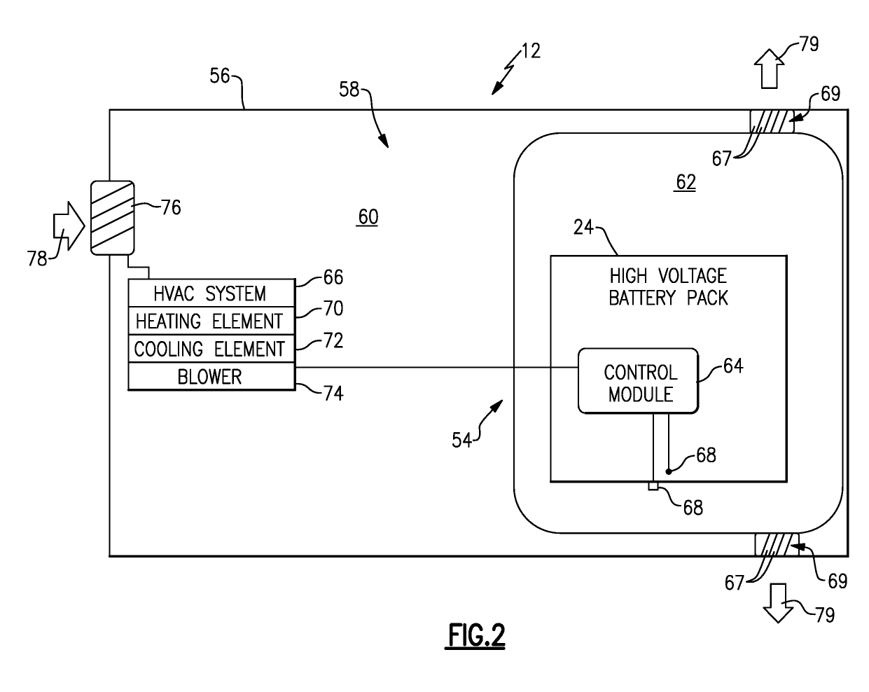

FIG. 2, with continued reference to FIG. 1, schematically illustrates a battery thermal management system 54 for managing the thermal load of a battery pack 24. The thermal management system 54 is described with reference to the electrified vehicle 12 of FIG. 1 for illustrative purposes only and is not intended to limit this disclosure in any way. The battery thermal management system 54 may be employed within any electrified vehicle that is equipped with a high voltage battery pack. In a non-limiting embodiment, the battery thermal management system 54 is an auxiliary system adapted to remove heat from within the electrified vehicle 12 in response to a heat soak that may occur in response to relatively hot ambient conditions.

The electrified vehicle 12 includes a vehicle body 56 that establishes an interior space 58. The interior space 58 may include a passenger cabin 60 and a cargo area 62, such as a trunk, that is at least partially climately separated from the passenger cabin 60. In a non-limiting embodiment, the battery pack 24 is mounted within the cargo area 62. However, the battery pack 24 could be mounted anywhere within the interior space 58, including under a passenger seat, under a floor board, etc.

In a non-limiting embodiment, the battery thermal management system 54 includes a control module 64, a heating, ventilation, and air conditioning (HVAC) system 66, one or more thermocouples 68, and one or more air extractors 69. During certain conditions, the battery thermal management system 54 can be controlled in a manner that results in evacuating hot air 79 from the cargo area 62 as quickly as possible in an effort to cool the battery pack 24.

The control module 64 is configured to control operation of the battery thermal management system 54. The control module 64 could be part of an overall vehicle control module 64, such as a vehicle system controller (VSC), or could alternatively be a stand-alone control module 64 separate from the VSC. In a non-limiting embodiment, the control module 64 is a battery electrical control module (BECM) associated with the battery pack 24.

The control module 64 may be programmed with executable instructions for interfacing with and operating various components of the battery thermal management system 54. The control module 64 includes various inputs and outputs for interfacing with the various components of the battery thermal management system 54, including but not limited to the HVAC system 66 and the thermocouple(s) 68. The control module 64 additionally includes a processing unit and non-transitory memory for executing the various control strategies and modes of the battery thermal management system 54.

The HVAC system 66 is equipped to modify a temperature inside the interior space 58, including within the passenger cabin 60 and/or the cargo area 62. The HVAC system 66 may include a heating element 70, a cooling element 72, and a blower 74. If heating is demanded within the passenger cabin 60, a fluid, such as water or coolant, is communicated to the heating element 70 for exchanging heat with airflow that is blown across the heating element 70 by the blower 74. The fluid loses heat to the airflow, which is then communicated to heat the passenger cabin 60 and/or the cargo area 62. Alternatively, if cooling is demanded within the passenger cabin 60, a refrigerant may be communicated to the cooling element 72. The refrigerant is expanded in the cooling element 72 and thus absorbs heat from airflow that is blown across the cooling element 72 by the blower 74. The airflow is then communicated to cool the passenger cabin 60 and/or the cargo area 62. In a non-limiting embodiment, the heating element 70 is a heater core and the cooling element 72 is an evaporator core. However, other heating and cooling devices may also be utilized to heat and/or cool the interior space 58 within the scope of this disclosure. In other words, the specifics of the HVAC system 66 are not intended to limit this disclosure.

The blower 74 may be controlled to cause airflow to flow through the HVAC system 66 and into the interior space 58. In a non-limiting embodiment, the blower 74 is a variable speed blower for causing airflow to flow into and through the heating and/or cooling elements 70, 72, through ducts and other conduits of the HVAC system 66, and then into the interior space 58.

Although not shown in the highly schematic depiction of FIG. 2, the HVAC system 66 could include an arrangement of ducts, conduits, doors, and/or actuators that are employable to direct airflow through either the heating element 70 or the cooling element 72 to adjust the temperature of the airflow. In another non-limiting embodiment, the HVAC system 66 includes an air inlet 76 for directing fresh air 78 from outside the electrified vehicle 12 into the interior space 58. In yet another non-limiting embodiment, the ducts, doors, conduits and/or actuators may be employed to control a mixture of the fresh air 78 with air that has been recirculated from the interior space 58. The ducts may be in fluid communication with the plurality of vents which direct the heated or cooled air into the interior space 58 for adjusting its temperature. In another non-limiting embodiment, one or more ducts may be positioned under a vehicle seat or vents may be added to cargo trim panels in order to channel air from the HVAC system 66 to the cargo area 62.

The thermocouple(s) 68 may be positioned to monitor temperatures inside and outside of the battery pack 24. In a non-limiting embodiment, at least one thermocouple 68 is positioned inside the battery pack 24 for monitoring the internal temperature of the battery pack 24 and at least one thermocouple 68 is positioned outside of the battery pack 24 for monitoring the external temperature of the battery pack 24. The battery thermal management system 54 could employ any number of thermocouples 68 within the scope of this disclosure. The control module 64 receives temperature feedback from the various thermocouples 68, and based on such feedback, the control module 64 can control the HVAC system 66 to deliver a desired level of heating or cooling to the battery pack 24.

The air extractors 69 may be configured as conduits that are specifically located to provide a path for communicating the hot air 79 from the interior space 58 to the exterior of the electrified vehicle 12. In a non-limiting embodiment, the air extractors 69 include one or more flaps 67 that are movable to allow the hot air 79 to escape through the air extractors 69. The battery thermal management system 54 could employ any number of air extractors 69 within the scope of this disclosure.

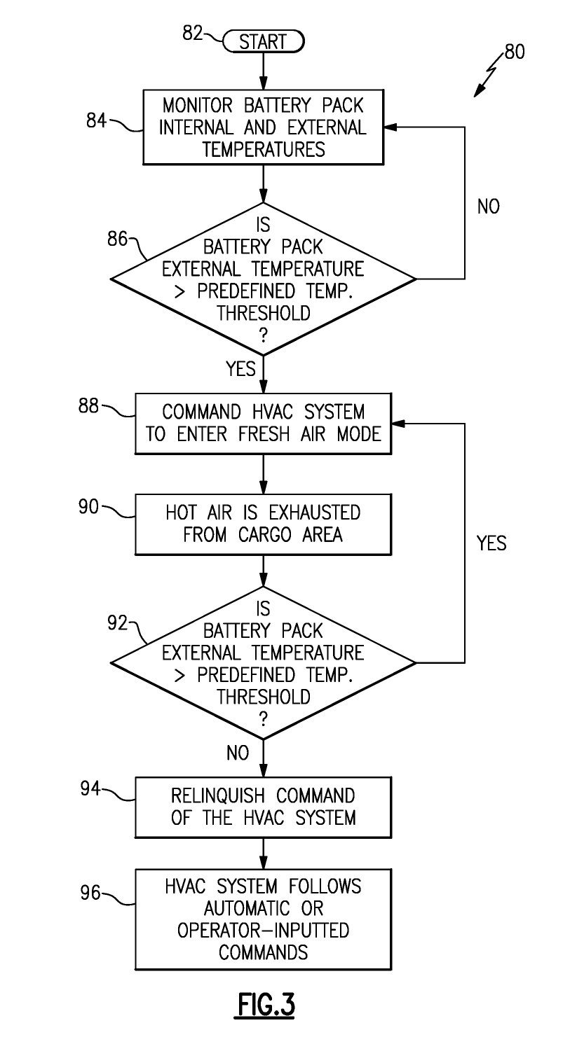

FIG. 3, with continued reference to FIGS. 1-2, schematically illustrates a control strategy 80 for controlling the battery thermal management system 54 of the electrified vehicle 12. For example, the control strategy 80 can be executed to thermally manage the battery pack 24. In a non-limiting embodiment, the control module 64 is programmed with one or more algorithms adapted to execute the exemplary control strategy, or any other control strategy. In another non-limiting embodiment, the control strategy is stored as executable instructions (e.g., as software code) in the memory of the control module 64.

The control strategy 80 begins at block 82. At block 84, the control module 64 monitors the internal and external temperatures of the battery pack 24. In a non-limiting embodiment, the thermocouple(s) 68 communicate temperature information of the battery pack 24 to the control module 64 during block 84.

At block 86, the control strategy 80 determines whether the external temperature of the battery pack 24 exceeds a predefined temperature threshold. The predefined temperature threshold is a temperature value stored in the memory of the control module 64. The internal temperatures of the battery pack 24 may be utilized to determine whether or not to reduce the load or completely shut off the battery pack 24.

If the temperature of the battery pack 24 exceeds the predefined temperature threshold at block 86, which could occur during relatively high heat ambient conditions due to the location of the battery pack 24 within the cargo area 62 (or any other mounting location of the battery pack 24) of the electrified vehicle 12, the control module 64 commands the HVAC system 66 into a fresh air mode at block 88 to deliver a desired level of cooling necessary to chill the battery pack 24 to an appropriate level. During fresh air mode, fresh air 78 is directed through the air inlet 76 and is then communicated by the HVAC system 66 to the cargo area 62. The fresh air 78 that is introduced into the cargo area 62 forces the hot air 79 to be exhausted from the cargo area 62 at block 90. The hot air 79 may be exhausted to a location external to the electrified vehicle 12, or external to the vehicle body 56, through one or more of the air extractors 69.

Next, at block 92, the control strategy 80 again checks whether the external temperature of the battery pack 24 exceeds the predefined temperature threshold. If YES, the control strategy 80 returns to block 88. Alternatively, if NO, the control strategy 80 proceeds to block 94 and the control module 64 relinquishes control of the HVAC system 66. In a non-limiting embodiment, the HVAC system 66 is prevented from entering a recirculation mode, in which air from within the interior space 58 is recirculated to cool the interior space 58, until after the temperature within the cargo area 62 falls below the predefined temperature threshold.

After relinquishing control of the HVAC system 66 at block 94, the control strategy 80 proceeds to block 96. The HVAC system 66 may follow automatic or operator-inputted commands at block 96.

In another non-limiting embodiment, such as for plug-in hybrid embodiments, the control strategy 80 may be performed when the electrified vehicle 12 is OFF and on-plug to pre-condition the battery pack 24 during certain conditions.

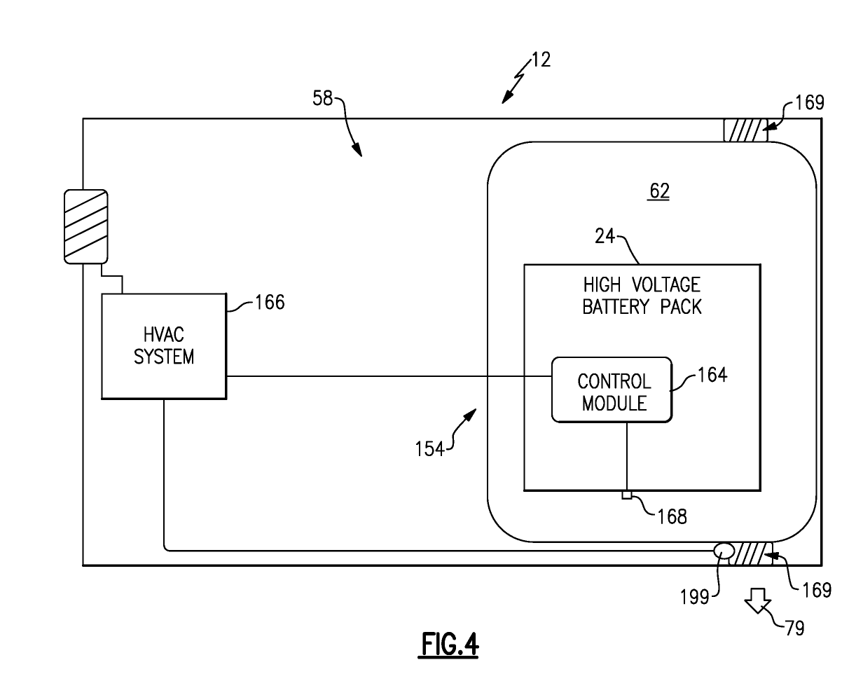

FIG. 4 illustrates another exemplary battery thermal management system 154 for an electrified vehicle 12. In this embodiment, the battery pack 24 is mounted within an interior space 58 of the electrified vehicle 12, such as within a cargo area 62 or any other portion of the interior space 58. In a non-limiting embodiment, the battery thermal management system 154 includes a control module 164, an HVAC system 166, one or more thermocouples 168, one or more air extractors 169, and one or more actuators 199 for actively opening and closing the air extractors 169.

During certain conditions, the battery thermal management system 154 can be controlled to evacuate hot air within the cargo area 62 as quickly as possible in order to cool the battery pack 24. For example, the battery thermal management system 154 can be controlled during relatively hot ambient conditions by controlling the actuator 199 to change a positioning of the air extractor 169. The actuator 199 may include a motor and an arm that is connected to the air extractor 169, in a non-limiting embodiment. Hot air 79 is permitted to escape the cargo area 62 through the partially opened air extractor 169, thereby cooling the battery pack 24.

In a first non-limiting embodiment, the actuator 199 is controlled by the HVAC system 166, which is itself controlled by the control module 164, to open and close the air extractor 169. In another non-limiting embodiment, the actuator 199 is controlled directly by the control module 164 to open and close the air extractor 169.

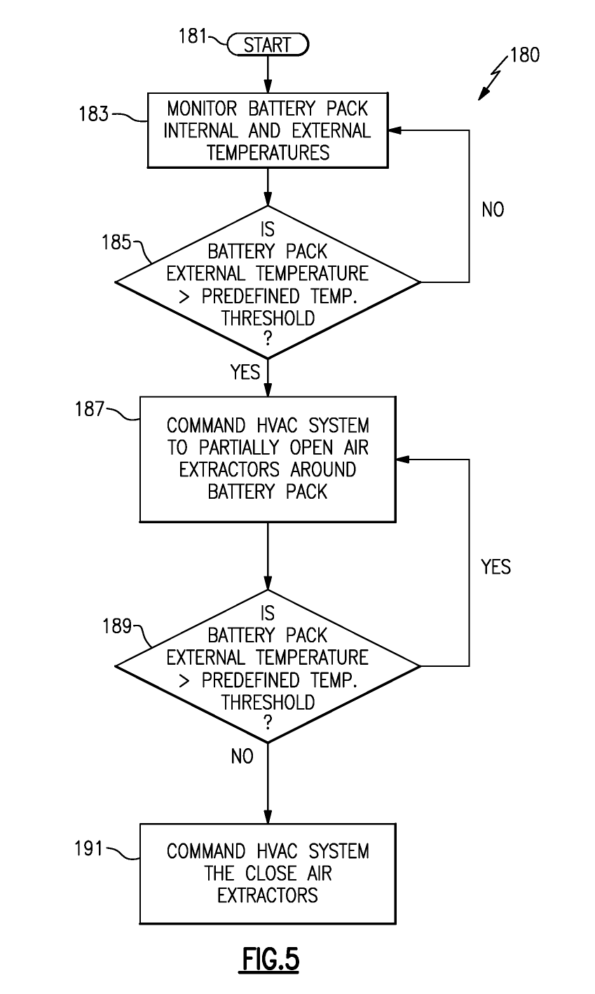

FIG. 5 schematically illustrates a control strategy 180 for controlling the battery thermal management system 154 of FIG. 4 in order to thermally manage the battery pack 24. The control strategy 180 begins at block 181. At block 183, the control module 164 monitors the internal and external temperatures of the battery pack 24. Next, at block 185, the control strategy 180 determines whether the external temperature of the battery pack 24 exceeds a predefined temperature threshold. If the temperature of the battery pack 24 exceeds the predefined temperature threshold, which could occur during relatively high heat ambient conditions due to the location of the battery pack 24 within the cargo area 62 of the electrified vehicle 12, the control module 164 may command the HVAC system 166 to open the air extractors 169 by actuating the actuators 199 at block 187. Hot air 79 may be exhausted to a location external to the electrified vehicle 12 through one or more of the air extractors 169.

Next, at block 189, the control strategy 180 again confirms whether the external temperature of the battery pack 24 exceeds the predefined temperature threshold. If NO, the control strategy 180 proceeds to block 191 and the control module 164 commands the HVAC system 166 to close the air extractors 169. Alternatively, the control module 164 could directly command the air extractors 169 to open and close.

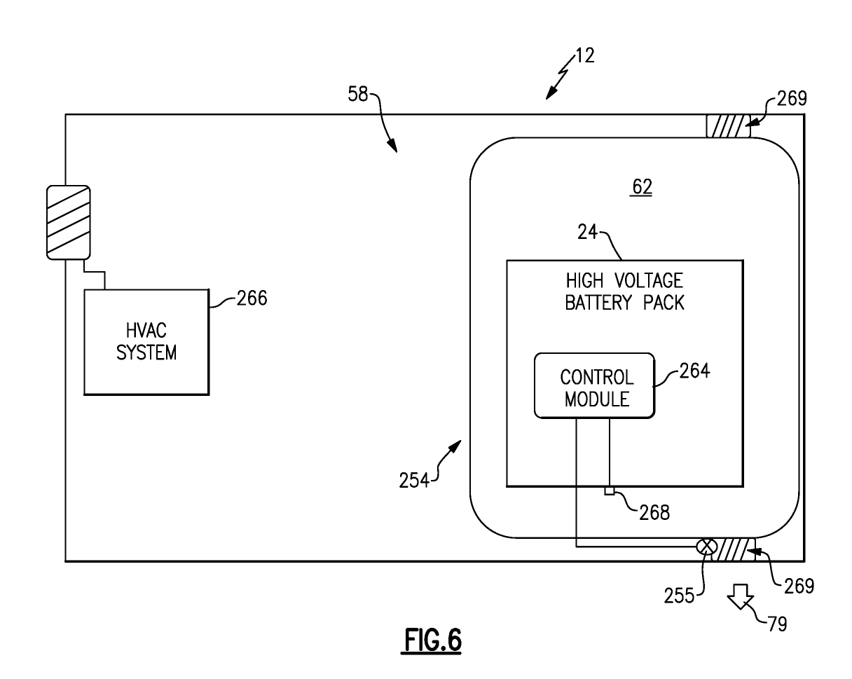

FIG. 6 illustrates yet another exemplary battery thermal management system 254 for an electrified vehicle 12. In this embodiment, the battery pack 24 is mounted within an interior space 58 of the electrified vehicle 12, such as within a cargo area 62, and therefore may be susceptible to a large heat soak during relatively hot ambient conditions. In a non-limiting embodiment, the battery thermal management system 254 includes a control module 264, an HVAC system 266, one or more thermocouples 268, one or more air extractors 269, and one or more fans 255.

During certain conditions, the battery thermal management system 254 can be controlled to evacuate hot air 79 within the cargo area 62 as quickly as possible in order to cool the battery pack 24. For example, the battery thermal management system 254 can be controlled during relatively hot ambient conditions by actuating the fan 255 to actively force hot air through the air extractor 269, thereby effectively cooling the battery pack 24. The fan 255 can be controlled by either the HVAC system 266 or directly by the control module 264.

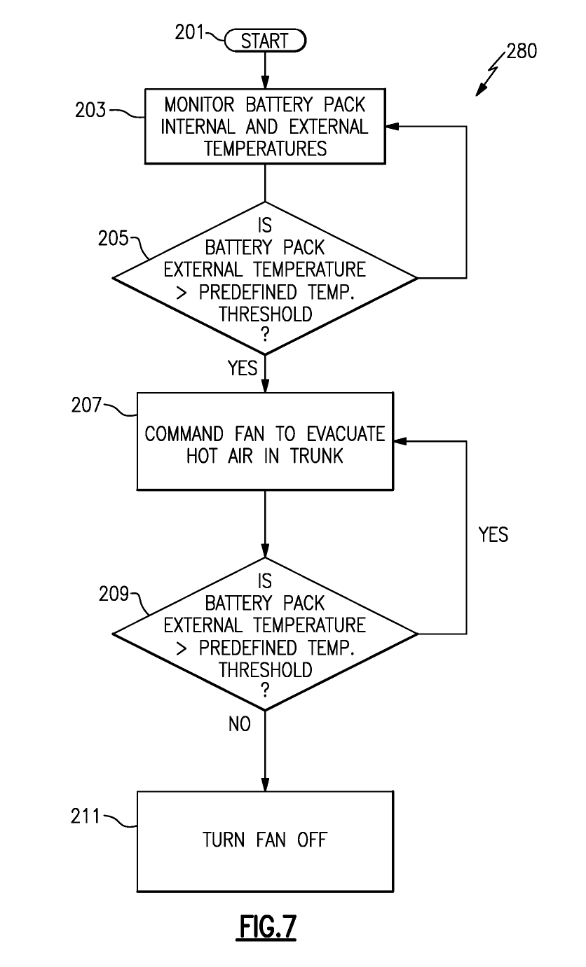

FIG. 7 schematically illustrates a control strategy 280 for controlling the battery thermal management system 254 of FIG. 6 in order to thermally manage the battery pack 24. The control strategy 280 begins at block 201. Next, at block 203, the control module 264 monitors the internal and external temperatures of the battery pack 24. At block 205, the control strategy 280 determines whether the external temperature of the battery pack 24 exceeds a predefined temperature threshold. If the temperature of the battery pack 24 exceeds the predefined temperature threshold, which could occur during relatively high heat ambient conditions due to the location of the battery pack 24 within the cargo area 62 of the electrified vehicle 12, the fan 255 is commanded ON to force hot air 79 through the air extractor 269 at block 207. Hot air 79 is exhausted to a location external to the electrified vehicle 12 through one or more of the air extractors 269.

Next, at block 209, the control strategy 280 again determines whether the external temperature of the battery pack 24 exceeds the predefined temperature threshold. If NO, the control strategy 280 proceeds to block 211 by commanding the fan 255 OFF.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. An electrified vehicle, comprising:
a vehicle body establishing an interior space;
a battery pack mounted within said interior space;
a battery thermal management system including a control module configured to command evacuation of hot air within said interior space through at least one air extractor if an external temperature of said battery pack exceeds a predefined temperature threshold.

2. The electrified vehicle as recited in claim 1, wherein said battery pack is mounted within a cargo area of said interior space.

3. The electrified vehicle as recited in claim 1, wherein said control module is a battery electrical control module (BECM).

4. The electrified vehicle as recited in claim 1, wherein said battery thermal management system includes a heating, ventilation, and air conditioning (HVAC) system, at least one thermocouple, and said at least one air extractor.

5. The electrified vehicle as recited in claim 4, wherein said control module is configured to command said HVAC system into a fresh air mode if said external temperature of said battery pack exceeds said predefined temperature threshold.

6. The electrified vehicle as recited in claim 4, wherein said at least one thermocouple is configured to detect said external temperature of said battery pack.

7. The electrified vehicle as recited in claim 4, wherein said at least one air extractor establishes a path for communicating said hot air from said interior space to an exterior of said vehicle body.

8. The electrified vehicle as recited in claim 1, wherein said battery thermal management system includes said at least one air extractor and an actuator configured to change a positioning of said at least one air extractor.

9. The electrified vehicle as recited in claim 8, wherein said control module is configured to command said actuator to change said positioning of said air extractor if said external temperature of said battery pack exceeds said predefined temperature threshold.

10. The electrified vehicle as recited in claim 8, wherein said control module is configured to command a HVAC system to command said actuator to change said positioning of said air extractor if said external temperature of said battery pack exceeds said predefined temperature threshold.

11. The electrified vehicle as recited in claim 1, wherein said battery thermal management system includes said at least one air extractor and a fan configured to force said hot air through said at least one air extractor.

12. The electrified vehicle as recited in claim 11, wherein said control module is configured to command said fan to force said hot air through said air extractor if said external temperature of said battery pack exceeds said predefined temperature threshold.

13. The electrified vehicle as recited in claim 1, wherein said battery thermal management system includes a first thermocouple configured to detect said external temperature and a second thermocouple configured to detect an internal temperature of said battery pack.

14. A method, comprising:
automatically evacuating hot air from an interior space of an electrified vehicle through an air extractor if an external temperature of a battery pack mounted within the interior space exceeds a predefined temperature threshold.

15. The method as recited in claim 14, wherein automatically evacuating the hot air from the interior space includes commanding a HVAC system into a fresh air mode to force the hot air out of the interior space.

16. The method as recited in claim 15, comprising preventing the HVAC system from operating in a recirculation mode until the external temperature is less than the predefined temperature threshold.

17. The method as recited in claim 15, wherein commanding the HVAC system into the fresh air mode includes:
directing fresh air through an air inlet; and
communicating the fresh air to the interior space to evacuate the hot air.

18. The method as recited in claim 14, wherein automatically evacuating the hot air from the interior space includes changing a positioning of the air extractor positioned to establish a path for communicating the hot air from the interior space to an exterior of the electrified vehicle.

19. The method as recited in claim 14, wherein automatically evacuating the hot air from the interior space includes actuating a fan to force the hot air through the air extractor.

20. The method as recited in claim 14, comprising:
monitoring the external temperature of the battery pack; and
comparing the external temperature to the predefined temperature threshold both before and after automatically evacuating the hot air from the interior space.

21. The electrified vehicle as recited in claim 1, wherein said at least one air extractor is mounted to said vehicle body.

22. The electrified vehicle as recited in claim 1, wherein said at least one air extractor includes a plurality of movable flaps.

23. The electrified vehicle as recited in claim 1, wherein said at least one air extractor is unattached to any ducting.

24. The method as recited in claim 14, wherein the hot air is evacuated through an opening of the air extractor.

25. The method as recited in claim 14, wherein automatically evacuating the hot air from the interior space includes communicating a fresh air into the interior space without passing the fresh air through the battery pack.

26. An electrified vehicle, comprising:
a vehicle body establishing an interior space;
a battery pack mounted within a cargo area of said interior space;
an air extractor mounted to said vehicle body;
a fan mounted immediately adjacent to said air extractor; and
a control module configured to actuate said fan to force air through an opening of said air extractor if a temperature of said battery pack exceeds a predefined temperature threshold.
